(19) United States
(12) Patent Application Publication
(10) Pub. No.: US 2007/0211996 A1
(43) Pub. Date: Sep. 13, 2007

(54) Laser bar coupler with improved brightness

(76) Inventor: Arkady Bablumyan, San Diego, CA (US)

Correspondence Address: COOLEY GODWARD KRONISH LLP;ATTN: Patent Group, Suite 500, 1200 - 19th Street, NW, Washington, DC, 20036-2402, US

(21) Appl. No.: 11/700,398

(22) Filed: Jan. 30, 2007

Related U.S. Application Data
(60) Provisional application No. 60/763,464, filed on Jan. 30, 2006.

(51) Int. Cl. G02B 6/26

(52) U.S. Cl. 385/43; 385/146

(57) ABSTRACT

A Laser Bar Coupler With Improved Brightness of the present invention includes a laser diode array having a number of spaced-apart laser elements, or diodes, each emitting laser radiation. The typical laser diode array laser elements are rectangular in shape, and linearly spaced apart along an axis with the long dimensions of the element along the axis. A number of optical fibers, or waveguides, each having an initially rectangular cross-section are placed adjacent each laser element and sized horizontally and vertically to approximate the rectangular dimensions of the laser element. The proximity and similar sizing of the input end of the rectangular optical fiber to the laser element provides for the near total reception of the optical energy from the laser element into the fiber. As the rectangular fibers extend away from the laser diode array, the optical fibers taper along the slow axis from its input having a dimension approximately the width of the laser emitter, to an output having a dimension which is less than the first dimension. Using this tapering technique, the optical power available at the output has a higher optical density, a significant brightness increase, and has a lower manufacturing cost than alternative and more complicated designs.

### RELATED APPLICATIONS

This application claims the benefit of priority to U.S. Provisional Patent Application Ser. No. 60/763,464 entitled “Laser Bar Coupler With Improved Brightness” filed Jan. 30, 2006, and currently co-pending.

### FIELD OF THE INVENTION

The present invention pertains generally to optical devices. The present invention is more particularly, though not exclusively, useful for combining the optical outputs of multiple elements in a laser diode array into a single optical fiber.

### BACKGROUND OF THE INVENTION

Laser arrays, in particular laser diode arrays (LDA), have long been known to provide a cost effective way of building a distributed source for high power laser applications. While somewhat cost effective, it is often very difficult to effectively transform the lateral laser array into a single optical output, such as a single optical fiber.

Over the years, a number of approaches have been developed to direct and combine the outputs of multiple LDAs to a single optical output. However, these solutions are often very complex and far too difficult to reliably create. Due to the very small tolerances and detailed manufacturing techniques, these devices are often prohibitively expensive to manufacture.

One device developed to combine multiple laser outputs to a single optical fiber is disclosed in U.S. Pat. No. 5,185,758 entitled “Multiple Laser-Pump Optical System” which issued to T. Fan, et al. in 1993. The Fan device includes a lens array carefully positioned in front of the laser elements to collimate the diverging light from the element. The light is then focused to a region, or spot, of high optical power to pump that region with the laser light from multiple laser elements.

Another device developed to combine multiple LDA outputs to a single fiber is shown and described in U.S. Utility Pat. No. 5,594,752 entitled “Diode Laser Source With Concurrently Driven Light Emitting Segments” which issued to J. Endriz in 1997. Like the Fan device, the Endriz apparatus includes an array of laser segments which each emit laser light which passes through a collimating lens assembly (lenslets) to form a plurality of collimated beams. These collimated beams pass through a common convergent lens array to focus upon a single point, such as the core of an optical fiber.

While the devices disclosed by Fan and Endiz may indeed serve the purpose of increasing the laser light intensity at the point of focus, it is very difficult to manufacture these devices due to the need for very precise positioning in the placement of the laser elements, lenslets, convergent lens and optical fiber. As a result of this high-precision manufacturing, these devices are very expensive to manufacture, and prone to failure due to vibration and impact.

In light of the above, it would be advantageous to provide a device capable of receiving laser light from an LDA and effectively and reliably directing the laser light to a common optical output, such as an optical fiber while providing an increased intensity of the light delivered to the optical fiber.

### SUMMARY OF THE INVENTION

The Laser Bar Coupler With Improved Brightness of the present invention includes a laser diode array having a number of spaced-apart laser elements, or diodes, each emitting laser radiation. The typical laser diode array laser elements are rectangular in shape, and linearly spaced apart along an axis with the long dimensions of the element along the axis.

A number of optical fibers, or waveguides, each having an initially rectangular cross-section are placed adjacent each laser element and sized horizontally and vertically to approximate the rectangular dimensions of the laser element. The proximity and similar sizing of the input end of the rectangular optical fiber to the laser element provides for the near total reception of the optical energy from the laser element into the fiber.

As the rectangular fibers extend away from the laser diode array, the optical fibers taper along the slow axis from its input having a dimension approximately the width of the laser emitter, to an output having a dimension which is less than the first dimension. Using this tapering technique, the optical power available at the output has a higher optical density, a significant brightness increase, and has a lower manufacturing cost than alternative and more complicated designs

Using the present technique, the intensity of the light delivered to a single optical fiber can be significantly greater than simply positioning optical fibers together. For instance, there can be M number of columns and N number of rows in order to maximize the optical power delivered to the input end of an optical fiber.

The tapered output ends of the waveguides are adjacent to a receiving end of an optical fiber. The proximity and similar sizing of the receiving end of the optical fiber to the combined size of the rectangular optical fibers provides for the near total reception of the optical energy from the rectangular fibers to the optical fiber.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of the Laser Bar Coupler With Improved Brightness of the present invention showing a laser diode array coupled to an optical fiber having a rectangular cross-section at its input end and tapers (linear and/or non-linear) each waveguide in the slow axis;

FIG. 2 is a side view of the Laser Bar Coupler With Improved Brightness of the present invention showing the placement of the laser diode array emitter with the input end of an optical fiber adjacent a laser diode and the fiber;

FIG. 3 is a top plan view of the Laser Bar Coupler With Improved Brightness of the present invention showing the FIG. 3 illustrates a typical tapered waveguide section that inherently increases the divergence in the slow axis but which has a negligible affect on performance as long as the slow axis increase is not more that the fast axis divergence;

FIG. 4 is a top view of the Laser Bar Coupler With Improved Brightness of the present invention showing the taper modification that allows the waveguide packing density for a given fiber size to be increased;

FIG. 5 is a Laser Bar Coupler With Improved Brightness of the present invention showing A four port Laser Bar Coupler as shown in FIG. 4 with the taper modification which allows the waveguide packing density for a given fiber size to be increased; and

FIG. 6 is an end view of the Laser Bar Coupler With Improved Brightness of the present invention showing a comparison between a tapered waveguide and a non-tapered waveguide wherein the tapering allows the waveguide packing density for a given fiber size to be increased.

### DETAILED DESCRIPTION OF A PREFERRED EMBODIMENT

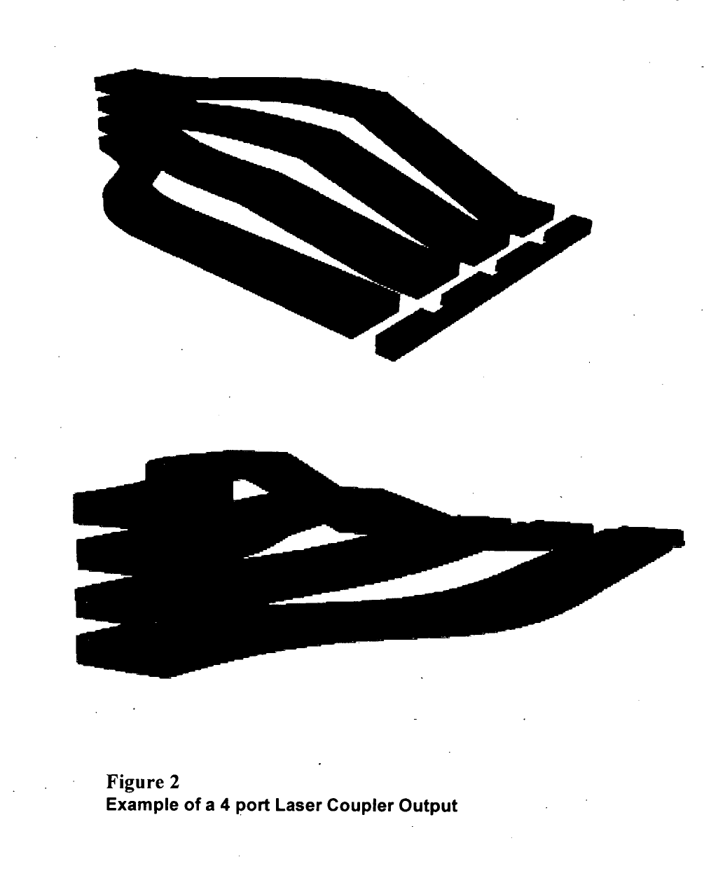

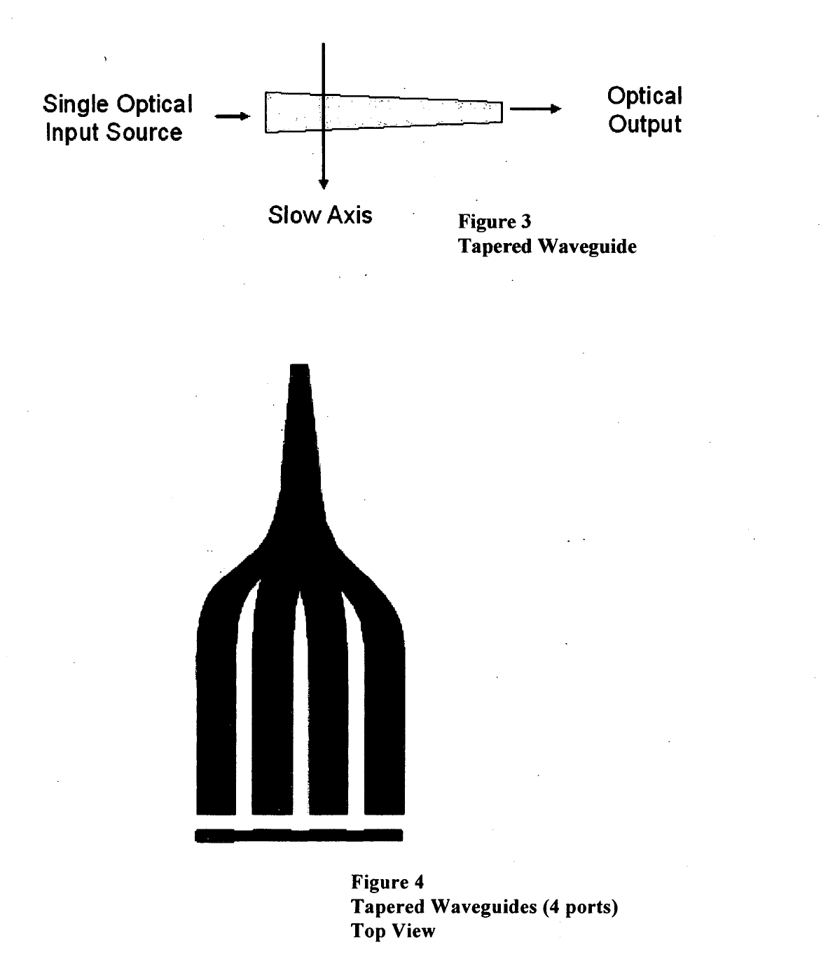

This invention takes the laser bar coupler shown in FIG. 1 and FIG. 2, and tapers (linear and/or non-linear) each waveguide in the slow axis. FIG. 3 illustrates a typical tapered waveguide section. This technique increases the divergence in the slow axis which has a negligible affect on performance as long as the slow axis increase is not more that the fast axis divergence.

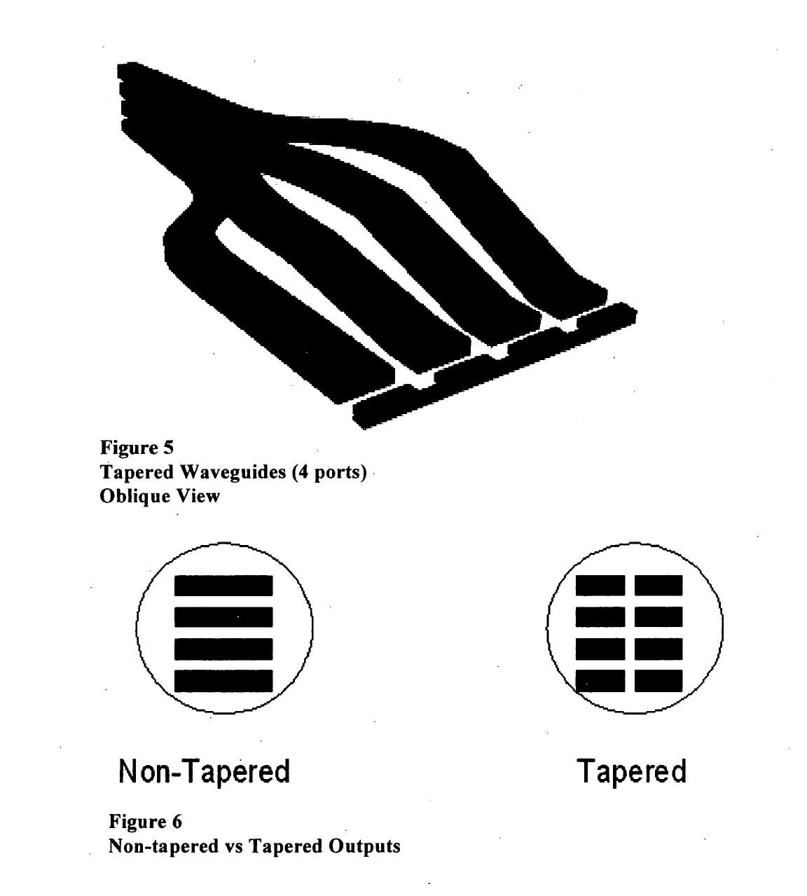

A four port Laser Bar Coupler is shown in FIG. 4 and FIG. 5 with the taper modification. The tampering allows the waveguide packing density for a given fiber size to be increased. This is illustrated in FIG. 6. There can be M number of columns and N number of rows with this technique.
The approach provides:
   Significant brightness increase
   Lower manufacturing cost
   Simpler design

FIG. 1 is a perspective view of the Laser Bar Coupler With Improved Brightness of the present invention showing a laser diode array coupled to an optical fiber having a rectangular cross-section at its input end and tapers (linear and/or non-linear) each waveguide in the slow axis.

FIG. 2 is a side view of the Laser Bar Coupler With Improved Brightness of the present invention showing the placement of the laser diode array emitter with the input end of an optical fiber adjacent a laser diode and the fiber.

FIG. 3 is a top plan view of the Laser Bar Coupler With Improved Brightness of the present invention showing the FIG. 3 illustrates a typical tapered waveguide section that inherently increases the divergence in the slow axis but which has a negligible affect on performance as long as the slow axis increase is not more that the fast axis divergence.

FIG. 4 is a top view of the Laser Bar Coupler With Improved Brightness of the present invention showing the taper modification that allows the waveguide packing density for a given fiber size to be increased.

FIG. 5 is a Laser Bar Coupler With Improved Brightness of the present invention showing A four port Laser Bar Coupler as shown in FIG. 4 with the taper modification which allows the waveguide packing density for a given fiber size to be increased.

FIG. 6 is an end view of the Laser Bar Coupler With Improved Brightness of the present invention showing a comparison between a tapered waveguide and a non-tapered waveguide wherein the tapering allows the waveguide packing density for a given fiber size to be increased.

While there have been shown what are presently considered to be preferred embodiments of the present invention, it will be apparent to those skilled in the art that various changes and modifications can be made herein without departing from the scope and spirit of the invention.

I claim:

1. A laser diode array translator, comprising:
a plurality of waveguides;
each said waveguide having an input and an output and formed with a core and cladding and having a longitudinal axis and a first rectangular cross-section at its input end and a second rectangular cross-section at its output end; and
each said waveguide tapering from said input end to said output end.
